(19) United States
(12) Patent Application Publication
(10) Pub. No.: US 2024/0382852 A1
(43) Pub. Date: Nov. 21, 2024

(54) INFORMATION PROCESSING DEVICE

(71) Applicant: Preferred Networks, Inc., Tokyo (JP)

(72) Inventors: Takuya SATO, Tokyo (JP); Keisuke MOCHIDA, Tokyo (JP); Takanori UZUKA, Tokyo (JP)

(21) Appl. No.: 18/663,687

(22) Filed: May 14, 2024

(30) Foreign Application Priority Data
May 17, 2023 (JP) 2023-081772

(51) Int. Cl. A63F 13/63; A63F 13/56; G09B 5/02

(52) U.S. Cl. CPC A63F 13/63; A63F 13/56; G09B 5/02

(57) ABSTRACT

An information processing device includes at least one memory; and at least one processor. The at least one processor is configured to allow visual programming for creating a program causing a character to perform a series of actions, the program being created by combining program components; and display a screen for selecting an object to be set in a program component indicating an action to be instructed to the character, the object being a target of the action. The screen displays a position of the object on a map of a space in which the character acts.

### CROSS-REFERENCE TO RELATED APPLICATIONS

This patent application is based on and claims priority to Japanese Patent Application No. 2023-081772 filed on May 17, 2023, the entire contents of which are incorporated herein by reference.

### TECHNICAL FIELD

The present disclosure relates to an information processing device.

### BACKGROUND

A programming learning device that supports learning of programming is used. Some programming learning devices are for visual programming of creating a program by combining program components in a block form or the like.

### RELATED ART DOCUMENT

### Patent Document

[Patent Document 1] Japanese Laid-open Patent Application Publication No. 2017-219718

### SUMMARY

According to one aspect of the present disclosure, an information processing device includes at least one memory; and at least one processor. The at least one processor is configured to allow visual programming for creating a program causing a character to perform a series of actions, the program being created by combining program components; and display a screen for selecting an object to be set in a program component indicating an action to be instructed to the character, the object being a target of the action. The screen displays a position of the object on a map of a space in which the character acts.

### BRIEF DESCRIPTION OF THE DRAWINGS

FIG. 1 is a block diagram illustrating an example of a functional configuration of an information processing device;

FIG. 2 is a diagram illustrating an example of a field screen;

FIG. 3 is a diagram illustrating an example of a programming screen;

FIG. 4 is a diagram illustrating an example of a selection screen;

FIG. 5 is a diagram illustrating an example of a selection screen after an object is selected;

FIG. 6 is a diagram illustrating an example of a programming screen after an object is selected;

FIG. 7 is a diagram illustrating an example of a program component whose action target is a field;

FIG. 8 is a diagram illustrating an example of a selection screen for selecting a field;

FIG. 9 is a diagram illustrating an example of a program component whose action target is an inventory;

FIG. 10 is a diagram illustrating an example of a selection screen for selecting the inventory;

FIG. 11 is a diagram illustrating an example of a program component whose action target is a craft;

FIG. 12 is a diagram illustrating an example of a selection screen for selecting the craft;

FIG. 13 is a diagram illustrating an example of a program component whose action target is an item;

FIG. 14 is a diagram illustrating an example of a selection screen for selecting the item;

FIG. 15 is a diagram illustrating an example of a program component whose action target is a prop;

FIG. 16 is a diagram illustrating an example of a selection screen for selecting the prop;

FIG. 17 is a flowchart illustrating an example of a processing procedure of an information processing method;

FIG. 18 is a diagram illustrating an example of a program list screen;

FIG. 19 is a diagram illustrating an example of a template setting screen;

FIG. 20 is a diagram illustrating an example of the template setting screen;

FIG. 21 is a diagram illustrating an example of the template setting screen;

FIG. 22 is a diagram illustrating an example of the programming screen; and

FIG. 23 is a block diagram illustrating an example of a hardware configuration of the information processing device.

### DETAILED DESCRIPTION OF EMBODIMENTS

In the following, embodiments of the present disclosure will be described with reference to the accompanying drawings. In the present specification and drawings, components having substantially the same functional configuration are denoted by the same reference numerals, and duplicated description thereof will be omitted.

### [Outline of Information Processing Device]

One embodiment of the present disclosure is an information processing device configured to execute a game program for providing a computer game. The computer game in the present embodiment is what is called an open world type computer game in which a character, which is an avatar of a player, is caused to perform various actions in a virtual space, which is the game world. The game world is not limited to the open world type. Additionally, the virtual space is not limited to a three-dimensional space, and may be a two-dimensional space. The computer game in the present embodiment has a function of creating a program for controlling an action of another character existing in the virtual space.

Hereinafter, a character operated by the player is also referred to as an “operated character”. Additionally, a character that can be controlled by a program is also referred to as a “controlled character”. The operated character and the controlled character exist in the virtual space, which is the game world.

In the computer game according to the present embodiment, an operation of causing the operated character to action is performed on a field screen on which the game world is rendered. The field screen is, for example, a screen on which the virtual space is displayed in the three dimensions. On the field screen, the operated character acts in the virtual space in response to the operation of the player. Examples of the operation that can be performed by the operated character include walking, running, jumping, attacking an enemy character, defending against an attack by an enemy character, acquiring an item, and working with a held item.

In the computer game of the present embodiment, the player can create a program for controlling the action of the controlled character. For example, the player can control the action of the controlled character in order to achieve an objective set in the virtual space. The objective to be achieved may be set by the player himself/herself or may be set by the game program in accordance with a progress of the computer game. The objective to be achieved may be, for example, constructing a building, harvesting a crop, manufacturing an item such as equipment, defeating an enemy character, and the like. The objective to be achieved is not limited to these, and any objective that can be realized in the virtual space may be set.

The controlled character is a non-player character (NPC) that is not operated by the player. The controlled character acts autonomously in the virtual space until the player creates a program.

The player selects a controlled character to be programmed on the field screen, and creates a program for causing the controlled character to perform a series of actions. The controlled character being a programming target performs the series of actions in the virtual space according to the program created by the player. The player may create a program for causing multiple controlled characters to perform respective different actions, and cause the multiple controlled characters to perform the actions in parallel. This program may be a program created separately for each controlled character, or may be a common program created for multiple controlled characters.

The program is created using a programming screen that allows visual programming. On the programming screen, one program is created by arranging program components having predetermined functions and connecting the program components. The program components include a component having a function of instructing the controlled character to perform an action, and a component having a function related to execution control such as a conditional branch or repetition.

A program component having a function for instructing the controlled character to perform an action includes a program component for setting an object to be an target of the action. The programming screen in the present embodiment displays a selection screen for selecting the object in order to set, in the program component, the object on which the action instructed by the program component is to be performed (an action target). On the selection screen, a map of a range in which the controlled character can act is displayed. Additionally, on the selection screen, a mark indicating a position of an object that is selectable as the action target is displayed. The selectable object differs depending on the nature of the action instructed by the program component.

The player sets the object being the action target in the program component by selecting the selectable object on the selection screen. Because the selectable object is displayed on the map of the range in which the controlled character can act on the selection screen, the player can easily specify an object of a desired action target. Additionally, because only an object that can be the action target is displayed in a selectable manner on the selection screen in accordance with the nature of the action (the display mode of the object switches in accordance with whether the object can be the action target), the player can set an appropriate object as the action target.

### [Functional Configuration of Information Processing Device]

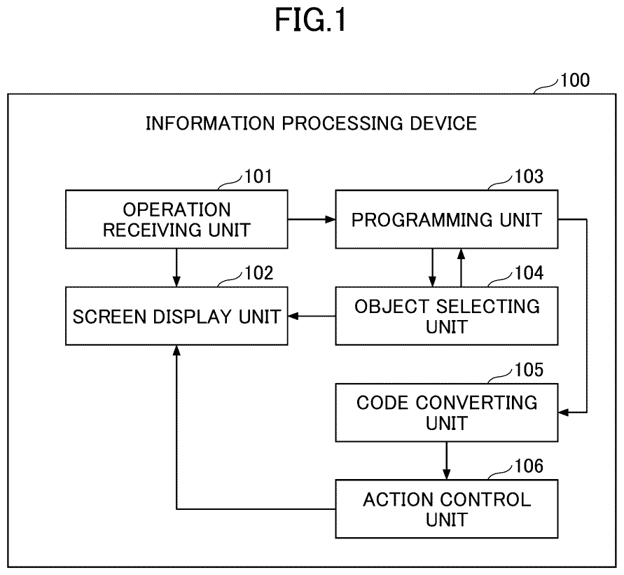

A functional configuration of the information processing device according to the embodiment of the present disclosure will be described with reference to FIG. 1. FIG. 1 is a block diagram illustrating an example of the functional configuration of the information processing device according to the present embodiment.

As illustrated in FIG. 1, an information processing device 100 according to the present embodiment includes an operation receiving unit 101, a screen display unit 102, a programming unit 103, an object selecting unit 104, a code converting unit 105, and an action control unit 106. The information processing device 100 functions as the operation receiving unit 101, the screen display unit 102, the programming unit 103, the object selecting unit 104, the code converting unit 105, and the action control unit 106 by executing a game program installed in advance.

The information processing device 100 is an information processing device such as a personal computer, a tablet computer, or a smartphone operated by the player of the computer game. The information processing device 100 may be a game console, a portable game console, or a non-portable game console. The information processing device 100 may include a display device configured to display a screen for the player to perform operations on the computer game. The display device may be a display or the like connected to the information processing device 100 via a wired or wireless interface.

The operation receiving unit 101 receives an operation by the player. The operation by the player is performed on a screen displayed on the display device by the computer game. The operation by the player differs depending on the type of screen on which the operation is performed. The operation receiving unit 101 performs control to execute another processing unit according to the content of the received operation.

The screen display unit 102 displays a screen on the display device according to the control of another processing unit. Additionally, the screen display unit 102 changes the contents of the screen displayed on the display device according to the control of another processing unit.

The programming unit 103 creates a program for controlling the action of the controlled character in accordance with the operation of the player on the programming screen. In the present embodiment, the program created by the programming unit 103 may be a visual program in which program components in a block form are arranged. The programming unit 103 creates the program by arranging the program components in the block form and connecting the program components in accordance with the operation of the player.

The object selecting unit 104 sets an object in the program component arranged on the programming screen. The object selecting unit 104 controls the screen display unit 102 to display a selection screen for selecting the object. The object selecting unit 104 sets, in the program component, the object selected by the player on the selection screen.

The code converting unit 105 generates a code that is executable by the computer game, based on the program created by the programming unit 103. The code generated by the code converting unit 105 may be described in a language in which instructions can be interpreted by the game program.

The action control unit 106 controls the action of the controlled character in the virtual space in accordance with the code generated by the code converting unit 105. The action control unit 106 controls the screen display unit 102 to display a state in which the controlled character performs actions on the field screen.

### [User Interface of Information Processing Device]

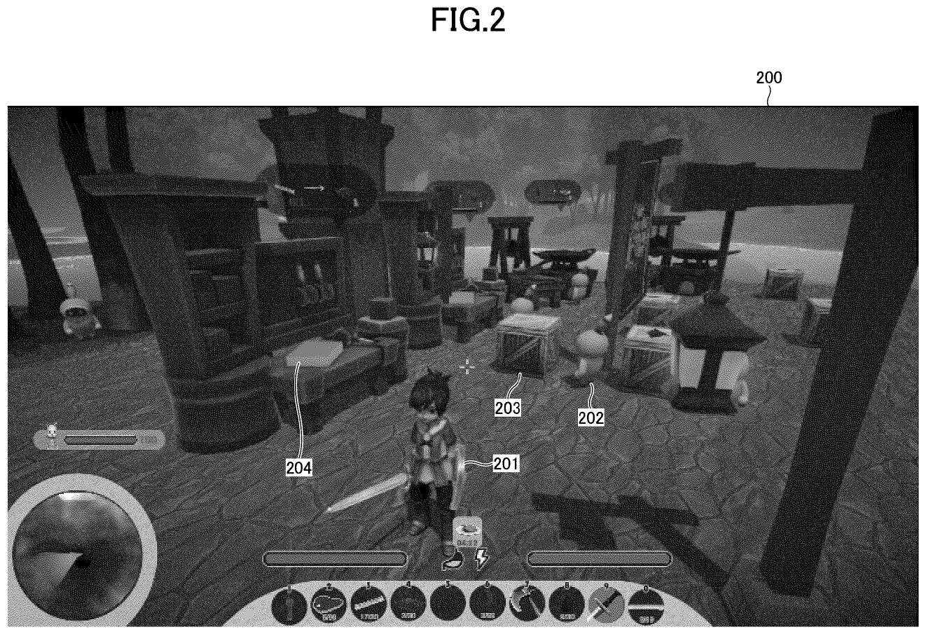

A user interface of the information processing device according to the embodiment of the present disclosure will be described with reference to FIG. 2 to FIG. 16. The user interface can be implemented as, for example, a screen displayed on the display device by the game program installed in the information processing device 100.

### <Field Screen>

The field screen in the present embodiment will be described with reference to FIG. 2. FIG. 2 is a diagram illustrating an example of the field screen.

As illustrated in FIG. 2, the virtual space is drawn on an entire field screen 200 in the three dimensions. An operated character 201, which is the avatar of the player, is displayed near the center of the field screen 200. The virtual space drawn on the field screen 200 is a range around the operated character 201.

A controlled character 202 being present around the operated character 201 is displayed on the field screen 200. Multiple controlled characters 202 may be displayed on the field screen 200. In FIG. 2, only the controlled character 202 that is close to the operated character 201 is denoted by a reference numeral.

The controlled character 202 may be also present in a range that is not displayed on the field screen 200. When the field of view of the field screen 200 is changed in accordance with the operation of the player, the controlled character 202 being present in the new field of view is displayed on the field screen 200.

A chest 203 in which various items can be accommodated and a workbench 204 on which work can be performed using the items are displayed on the field screen 200 illustrated in FIG. 2.

When the operated character 201 and the controlled character 202 approach within a predetermined range from the chest 203, they can open the door of the chest 203 and take out the item stored in the chest 203. Additionally, when the operated character 201 and the controlled character 202 approach the workbench 204 with an item being held, they can place the item on the workbench. Furthermore, when the item is placed on the workbench 204, the operated character 201 and the controlled character 202 can perform work using the item. The work that can be performed on the workbench 204 depends on a type of the workbench 204, and examples include work of manufacturing a new item by combining multiple items.

When the player performs an operation of selecting the controlled character 202 on the field screen 200, the programming screen is activated. The activated programming screen may be displayed to be superimposed on a part of the field screen 200 or may be displayed to be superimposed on an entirety of the field screen 200. The programming screen is activated in a state in which a program for causing the selected controlled character 202 to perform the action can be created.

### <Programming Screen>

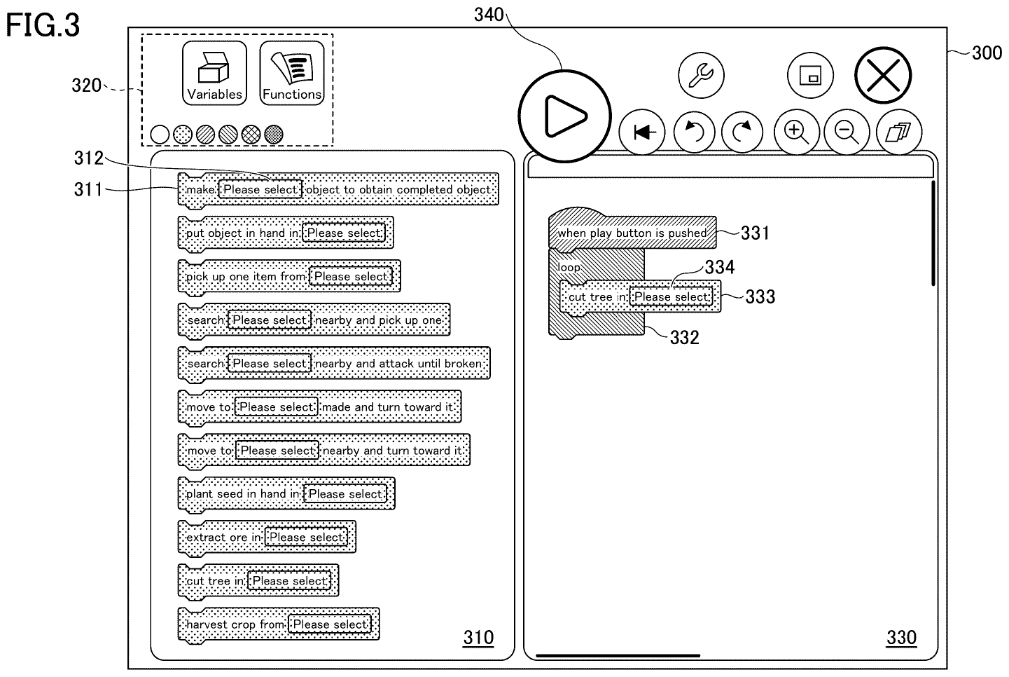

The programming screen in the present embodiment will be described with reference to FIG. 3. FIG. 3 is a diagram illustrating an example of the programming screen.

As illustrated in FIG. 3, a programming screen 300 includes a selection area 310, a switch button 320, an arrangement area 330, and a play button 340.

A list of program components 311 that can be used in the program is displayed in the selection area 310. The switch button 320 is a button for switching the program component displayed in the selection area 310.

The program component that instructs the action may be able to set an object as the objective of the action. The program component in which the object can be set may include an input field for setting the object. In the example illustrated in FIG. 3, the program component 311 displayed in the selection area 310 includes an input field 312 in which the object can be set. In the input field 312, a text indicating that the setting of the object is necessary (for example, “Please select” or the like) may be displayed.

The player creates a program by selecting a desired program component in the selection area 310 and arranging the program component in the arrangement area 330. The operation of arranging the program component is, for example, an operation of dragging and dropping the program component from the selection area 310 into the arrangement area 330.

The player creates one program by connecting the program components in the arrangement area 330. In the present embodiment, functions indicated by the program components are performed in the order from the top to the bottom of the arrangement area 330. In the arrangement area 330, when the program component is arranged, control may be performed so that a program component automatically connected to a program component in the vicinity.

In the arrangement area 330, the order of the program components may be changed by the operation of the player. For example, the player may change the order of the program components by selecting a desired program component in the arrangement area 330 and dragging the program component upward or downward.

The play button 340 is a button for starting execution of the created program. When the player presses the play button 340, first, a program component in which an error occurs is detected from the program created in the arrangement area 330. If the program component in which the error occurs is detected, the execution of the program is interrupted, and the error is notified to the player. If no program component in which an error occurs is detected, the controlled character sequentially performs the instructed actions in accordance with the arrangement of the program components in the arrangement area 330.

In FIG. 3, as an example of the program, one program in which three program components 331 to 333 are connected is illustrated. The program component 331 is a program component indicating a condition that triggers the program. The program component 332 is a program component indicating repeat control. The program component 333 is a program component instructing the controlled character to perform the action. The program component 333 has an input field 334 for setting, in the program component 333, an object to be an action target of the action of the controlled character instructed by the program component 333.

The program indicated in FIG. 3 is a program for causing the controlled character to perform the following actions.
(1) Start the program when the play button is pressed (the program component 331).
(2) Cut the tree of the object set as the action target (the program component 333).
(3) Perform the above action (2) repeatedly (the program component 332).

In the program indicated in FIG. 3, a message indicating that the setting of the object is necessary is displayed in the input field 334. When the player performs an operation for selecting an object in the input field 334, a selection screen for selecting the object is displayed. Here, the operation for selecting the object is, for example, an operation of clicking or tapping the input field 334, or the like.

### <Selection Screen>

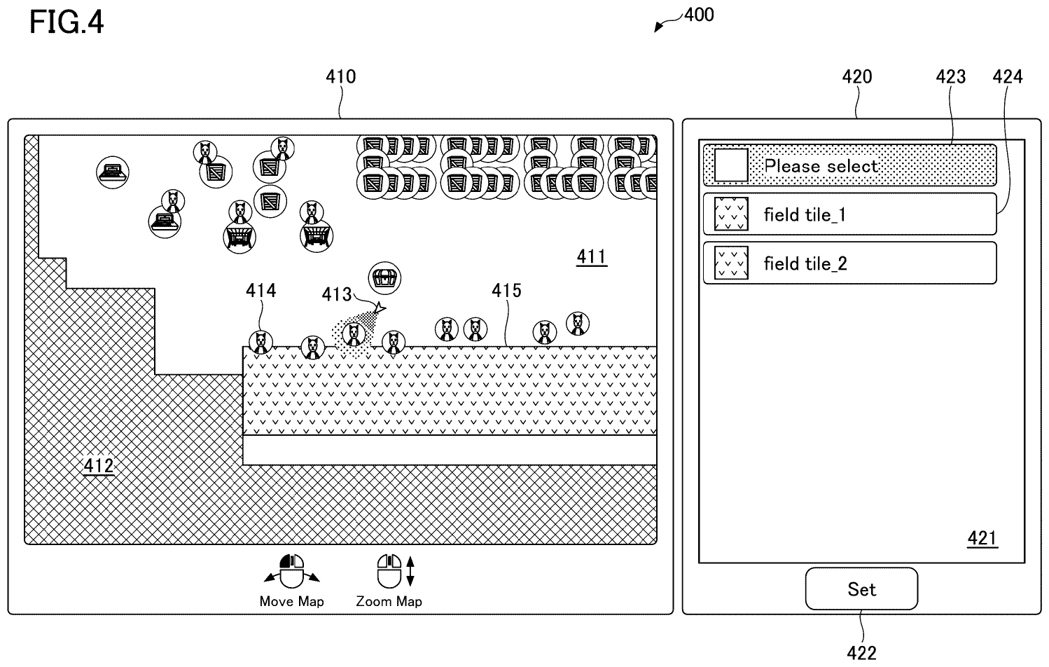

The selection screen in the present embodiment will be described with reference to FIG. 4 to FIG. 16. FIG. 4 is a diagram illustrating an example of the selection screen.

As illustrated in FIG. 4, a selection screen 400 includes a map area 410 and a list area 420. In the map area 410, a map of an entire area of a town to which the controlled character belongs is displayed. In the map area 410, a map of the vicinity of the operated character may be displayed. In the list area 420, a list of objects selectable as the action target is displayed.

In the present embodiment, the range of the town may be defined by an instruction from the player. However, the range of the town may be automatically defined by the game program in accordance with the progress of the game. The map displayed in the map area 410 may be enlarged or reduced within a range in which the visibility of the objects displayed on the map is not impaired.

In the map area 410, a mark 413 indicating the position of the operated character and a mark 414 indicating the position of the controlled character are displayed. In FIG. 4, only representative controlled characters are denoted by the reference numerals.

The map area 410 includes an actionable range 411 indicating a range in which the controlled character can act, and a non-actionable range 412 indicating a range in which the controlled character cannot act. In the actionable range 411, a selectable range 415 indicating an object selectable as the action target is highlighted. In FIG. 4, a mark indicating the position of the object is not displayed in the non-actionable range 412, but a mark indicating the position of the object present in the non-actionable range 412 may be displayed.

In the map area 410 illustrated in FIG. 4, the selectable range 415 is drawn in a color different from that of the actionable range 411. The mode of highlighting is not limited to the difference in color, and the highlighting may be performed in any mode as long as the difference in type can be identified, such as a difference in the shape, a difference in the outline, a difference in the hatching, or a combination thereof, for example.

In the list area 420, an object list 421 and a set button 422 are displayed. The object list 421 includes an item 423 indicating that an object is not selected and an item 424 indicating an object selectable as the action target.

When the player selects any of the items 424 indicating the objects in the object list 421, control enabling the set button 422 to be pressed is performed. When the player presses the set button 422, the object selected from the object list 421 is set as the action target in the program component.

Although two objects 424 are displayed in the object list 421 illustrated in FIG. 4, the number of the objects displayed in the object list 421 changes depending on the number of objects selectable as the action target.

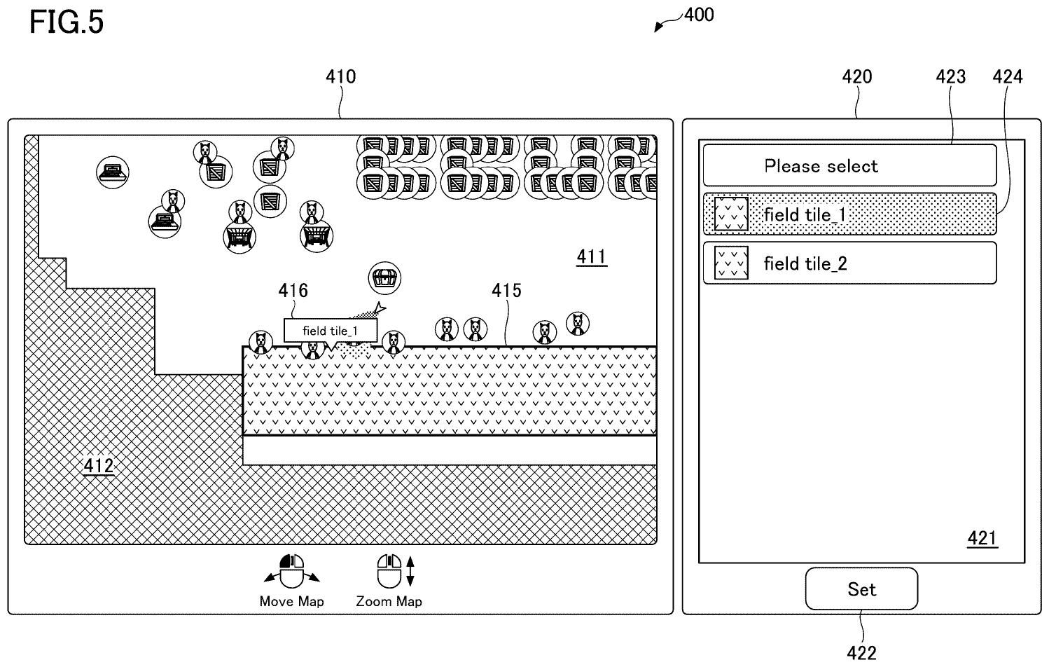

FIG. 5 is a diagram illustrating an example of a selection screen after the object is selected. In the selection screen 400 illustrated in FIG. 5, the object 424 named “field tile_1” is selected in the list area 420. When any object is selected in the list area 420, a mark indicating the position of the selected object may be displayed in the map area 410. In the selection screen 400 illustrated in FIG. 5, a mark 416 indicating the position of “field tile_1” is displayed in the map area 410.

Here, although the example in which the position of the object selected in the list area 420 is displayed in the map area 410 has been described, the object selected in the map area 410 may be automatically selected in the list area 420. In other words, a selection state in the map area 410 and a selection state in the list area 420 may be linked.

The actionable range 411 may be a part of a range in which the controlled character can act. The examples illustrated in FIG. 4 and FIG. 5 indicate that the range in which the controlled character can act is extended in the upper direction and the right direction of the map area 410. The object list 421 may include an item indicating an object that is present outside the range indicated in the actionable range 411. In the examples illustrated in FIG. 4 and FIG. 5, the object named “field tile_1” is displayed in the actionable range 411 of the map area 410, but the object named “field tile_2” is not displayed.

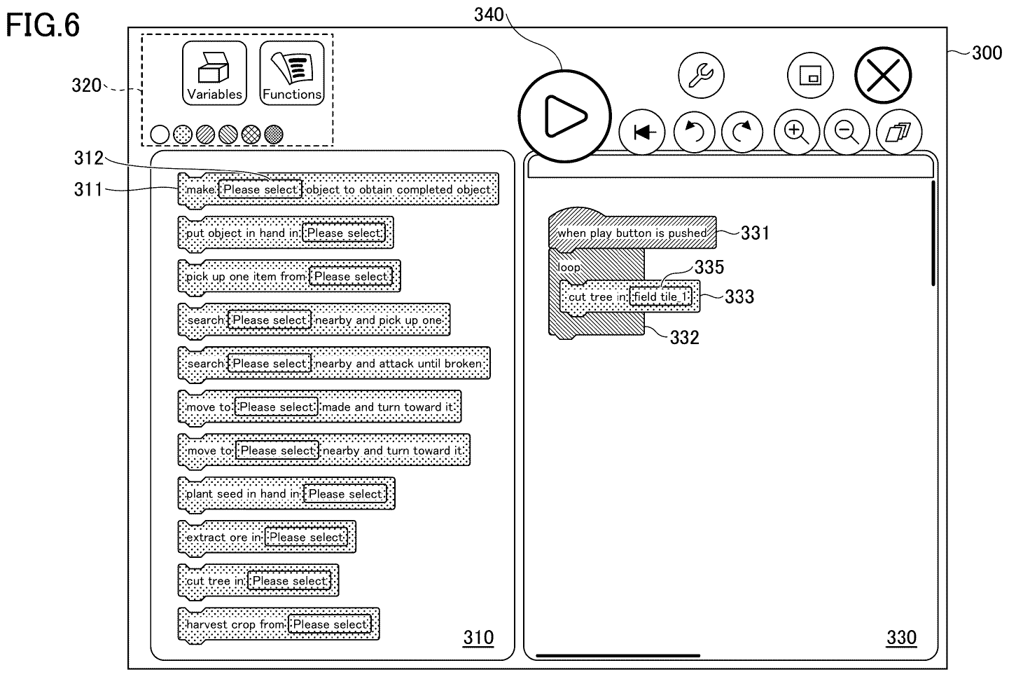

FIG. 6 is a diagram illustrating an example of a programming screen after the object is selected. In the programming screen 300 illustrated in FIG. 6, the name (“field tile_1”) of the object selected in the selection screen 400 is set in an input field 335 of the program component 333 arranged in the arrangement area 330.

The selection screen 400 illustrated in FIG. 4 and FIG. 5 displays the object by switching a display mode of the object depending on whether the object can be the target of the action of the controlled character. Specifically, the selection screen 400 displays the positions of all objects that are present in the range in which the controlled character can act, and is in a display mode in which an object that can be the action target is selectable, but an object that cannot be the action target is not selectable.

The display mode for displaying the objects to be selectable may be, for example, the following display mode. A first display mode is a display mode in which all objects are displayed on the selection screen 400, but an object that cannot be the action target is not selectable. In this display mode, an object that can be the action target is displayed and selectable.

In the first display mode, even when a selection operation is performed on an object that cannot be the action target, control is performed such that the selection operation is not accepted. The phrase “selection operation is not accepted” indicates that no object has been set in the input field of the program component. The fact that no object has been set may include, for example, that the object is not selected (for example, there is no response even if clicked), the set button cannot be pressed even though the object can be selected, or the object is not set to the program component even though the object can be selected and the set button can be pressed.

In a second display mode, only objects that can be the action target are displayed, and control is performed such that an object to be the action target is selected from the displayed objects. In this display mode, an object that cannot be the action target is not displayed.

### <<Specific Example of Selectable Object>>

Only objects that can be the action target in accordance with the nature of the action are displayed on the selection screen 400 in a selectable manner. A relationship between the nature of the action and the selectable objects will be described in more detail below.

A first example of the selectable object is “field”. The field is a place where a crop can be grown by planting seeds and the grown crop can be harvested in the virtual space.

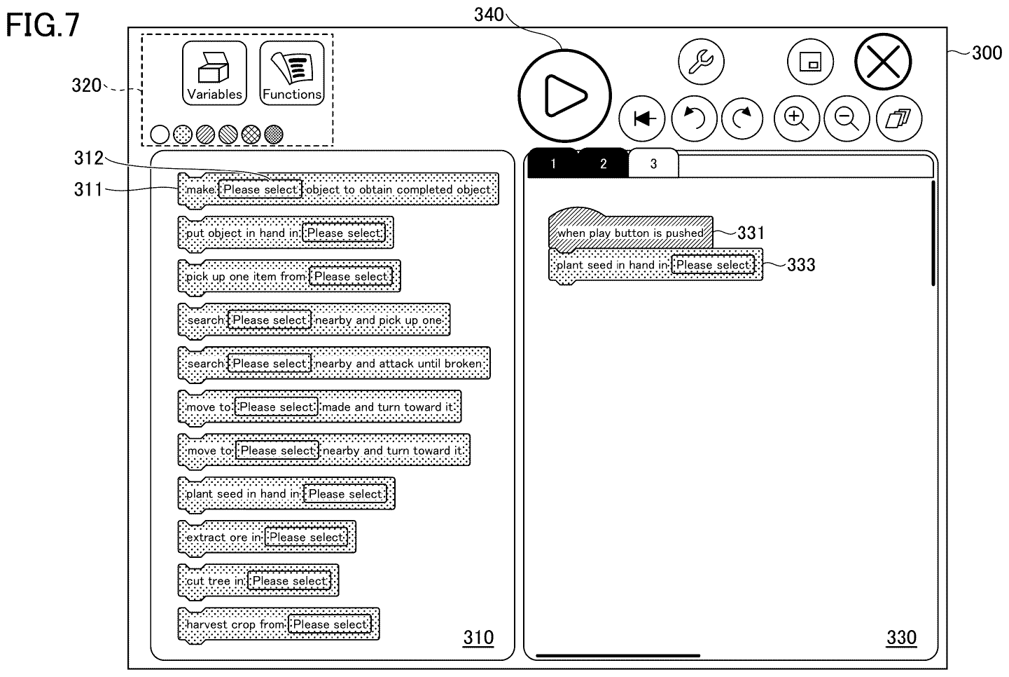

FIG. 7 is a diagram illustrating an example of a program component whose action target is the field. As illustrated in FIG. 7, a program component for instructing an action of “plant seed in hand in.” can select “field” as the action target.

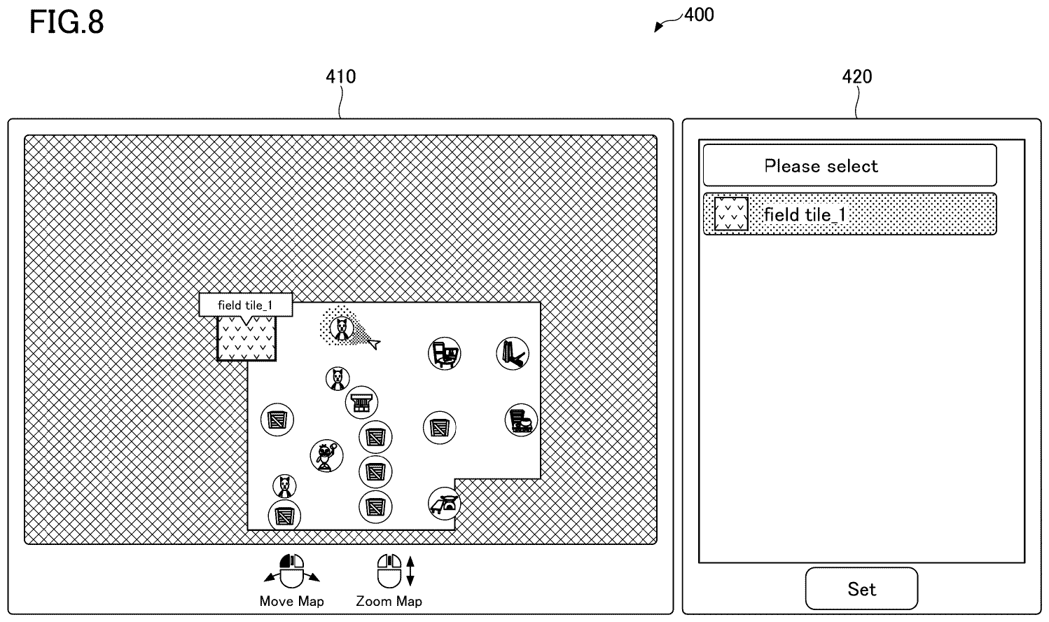

FIG. 8 is a diagram illustrating an example of a selection screen for selecting the field. As illustrated in FIG. 8, in the selection screen 400 for selecting the field as the action target, only the “field” object is displayed in the map area 410 and the list area 420 in a selectable manner.

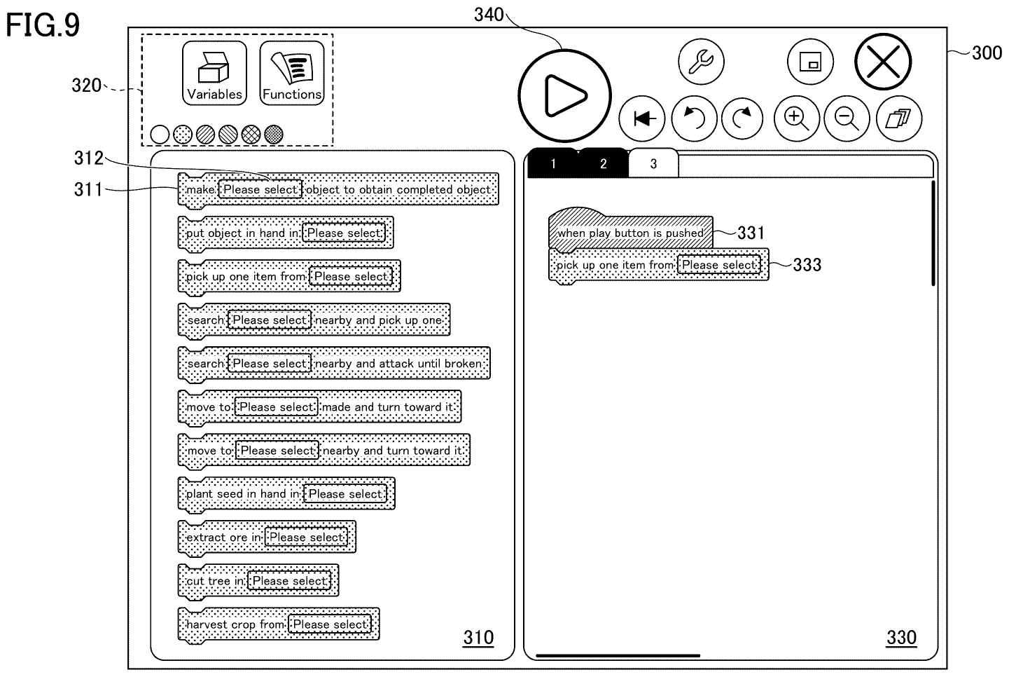

A second example of the selectable object is “inventory”. The inventory is equipment that can accommodate an item. Examples of the inventory include a chest, a container, and the like. FIG. 9 is a diagram illustrating an example of a program component whose action target is the inventory. As illustrated in FIG. 9, a program component for instructing an action of “pick up one item from . . . ” can select “inventory” as the action target.

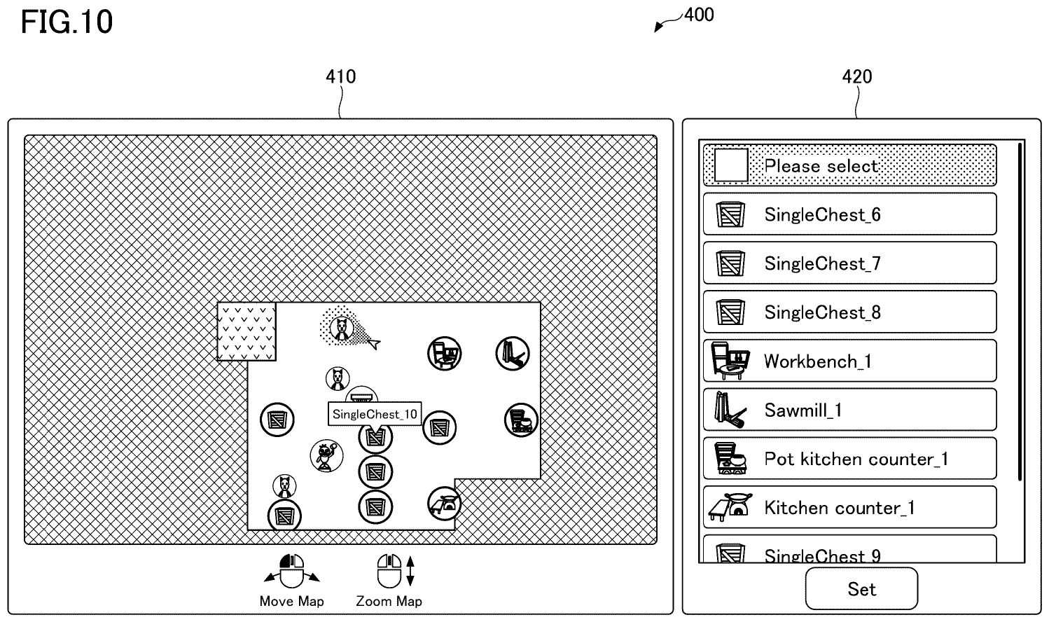

FIG. 10 is a diagram illustrating an example of a selection screen for selecting the inventory. As illustrated in FIG. 10, in the selection screen 400 for selecting the inventory as the action target, only the objects corresponding to the inventory are displayed in the map area 410 and the list area 420 in a selectable manner.

A third example of the selectable object is “craft”. The craft is equipment used to make (craft) another item by processing an item acquired in the virtual space or by combining the item with another item. Examples of the craft include a workbench and a furnace.

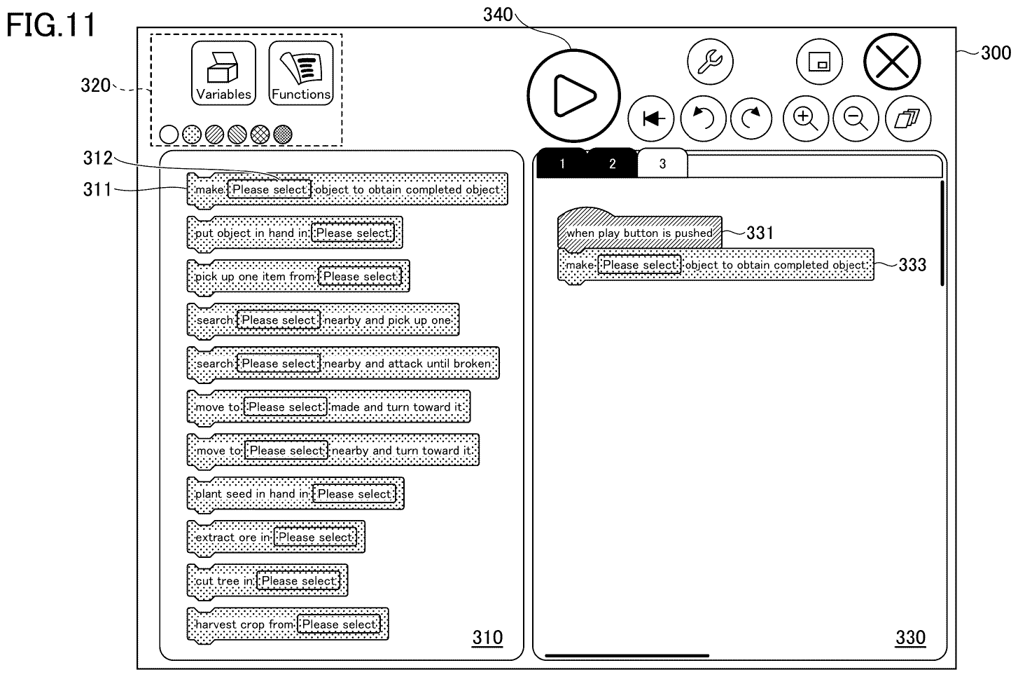

FIG. 11 is a diagram illustrating an example of a program component whose target action is the craft. As illustrated in FIG. 11, a program component for instructing an action of “make . . . object to obtain completed object” can select “craft” as the action target.

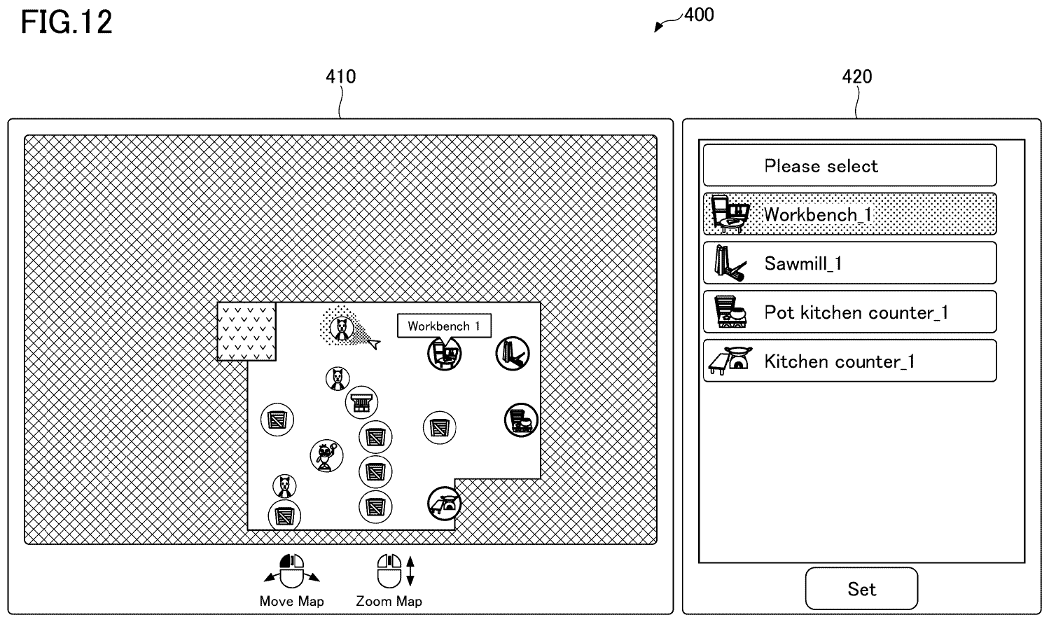

FIG. 12 is a diagram illustrating an example of a selection screen for selecting the craft. As illustrated in FIG. 12, in the selection screen 400 for selecting the craft as the action target, only the objects corresponding to the craft are displayed in the map area 410 and the list area 420 in a selectable manner.

A fourth example of the selectable object is “item”. The item is an object that can be acquired in the virtual space. The item may be accommodated in the inventory or may be used as a material in the craft. Examples of the item include a tree, a stone, and the like.

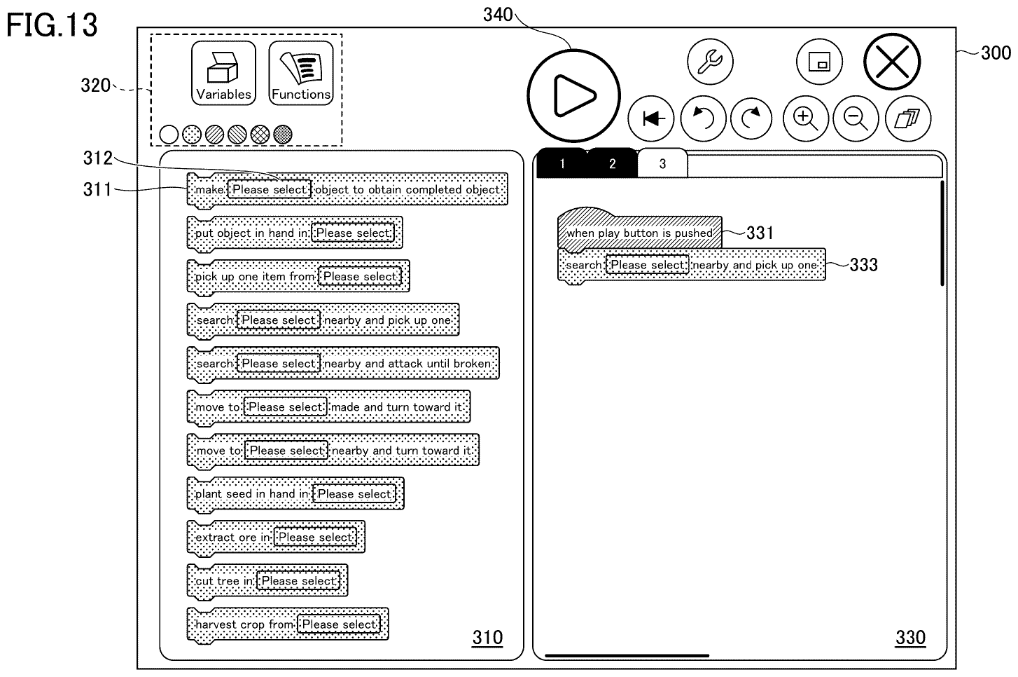

FIG. 13 is a diagram illustrating an example of a program component whose target action is the item. As illustrated in FIG. 13, a program component for instructing an action of “search . . . nearby and pick up one” can select “item” as the action target.

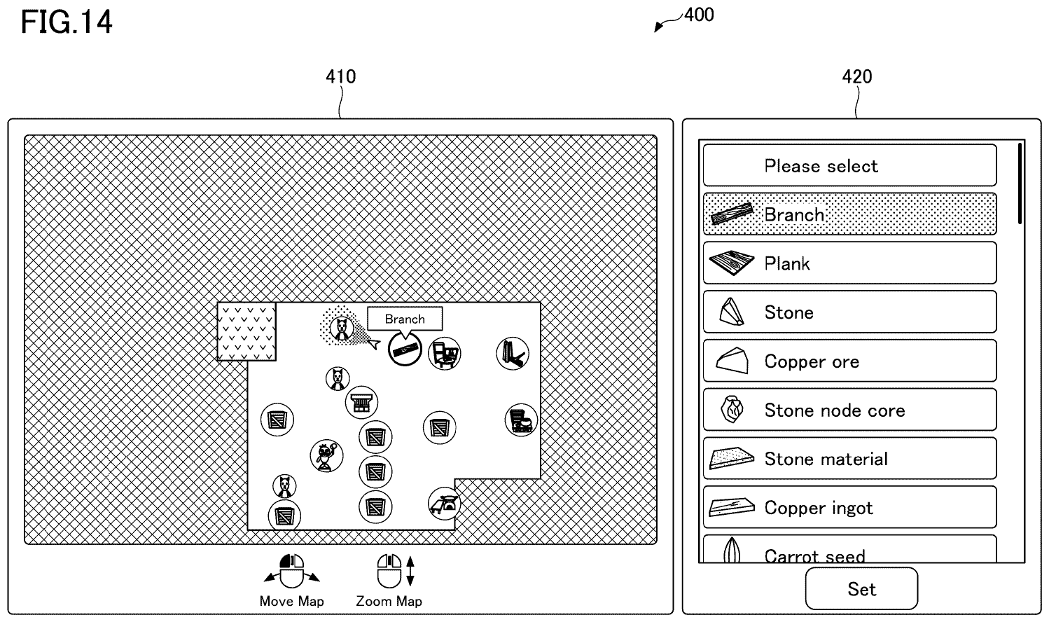

FIG. 14 is a diagram illustrating an example of a selection screen for selecting the item. As illustrated in FIG. 14, on the selection screen 400 for selecting an item as the action target, only objects corresponding to the item are displayed in the map area 410 and the list area 420 in a selectable manner.

A fifth example of the selectable object is “prop”. The prop is an object that can be placed in the virtual space. The prop does not have a special function, but can start or stop a predetermined operation. The prop can be placed to arrange the landscape of the virtual space. Examples of the prop include a fountain and a torch.

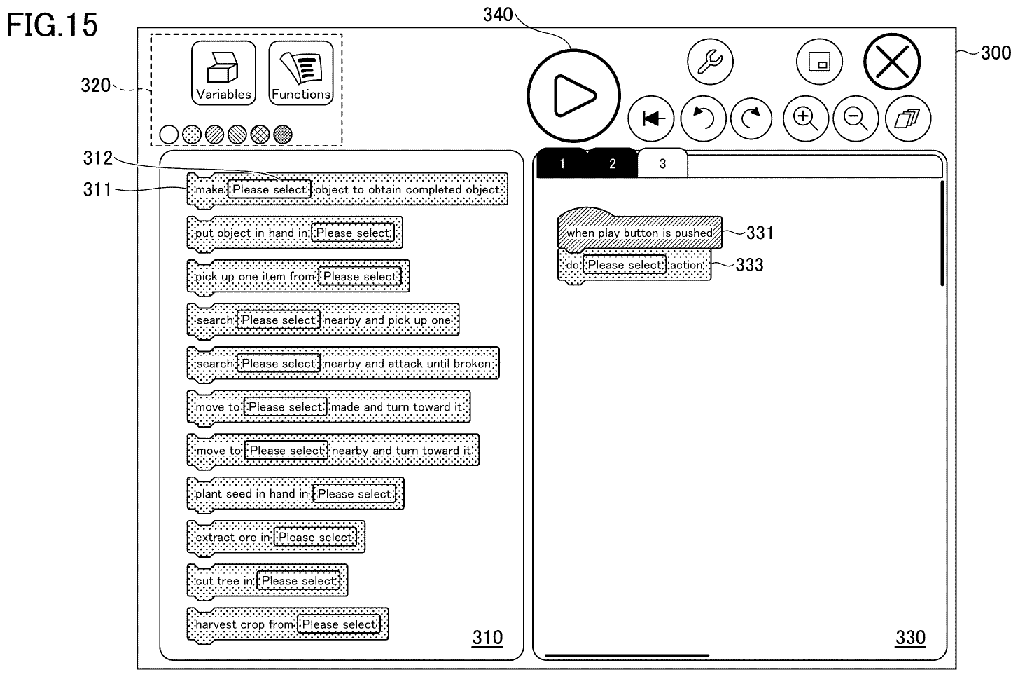

FIG. 15 is a diagram illustrating an example of a program component whose action target is the prop. As illustrated in FIG. 15, a program component for instructing an action of “do . . . action” can select “prop” as the action target.

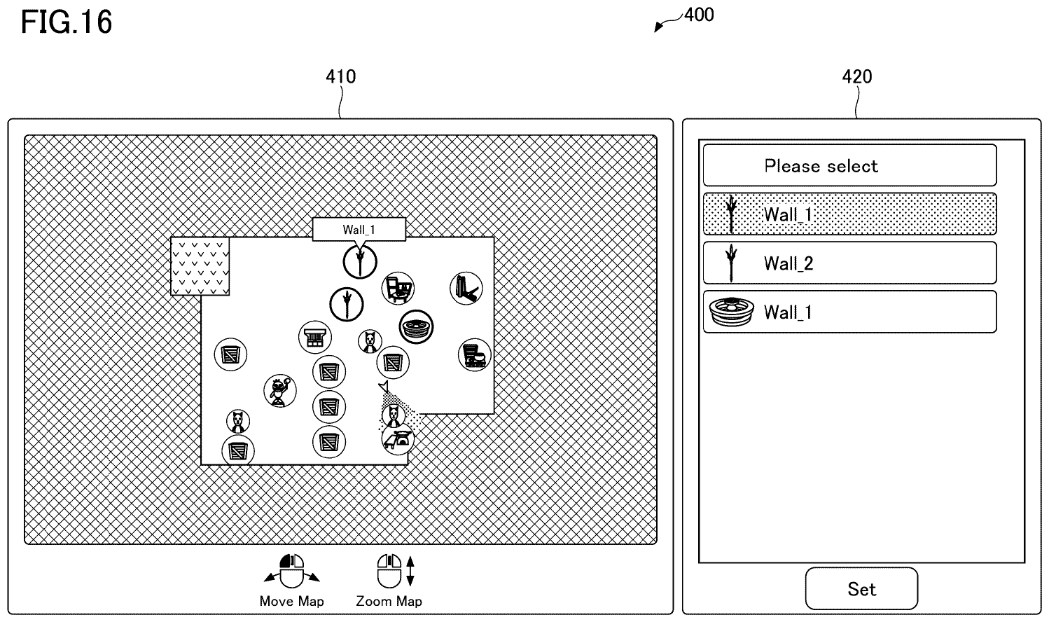

FIG. 16 is a diagram illustrating an example of a selection screen for selecting the prop. As illustrated in FIG. 16, on the selection screen 400 for selecting the prop as the action target, only objects corresponding to the prop are displayed in the map area 410 and the list area 420 in a selectable manner.

Although the field, the inventory, the craft, the item, and the prop have been described as specific examples of the selectable object here, the selectable object is not limited to these. Any object suitable as a target of an action that can be performed in the virtual space may be displayed on the selection screen as the selectable object in accordance with the content of the action.

### [Processing Procedure of Information Processing Method]

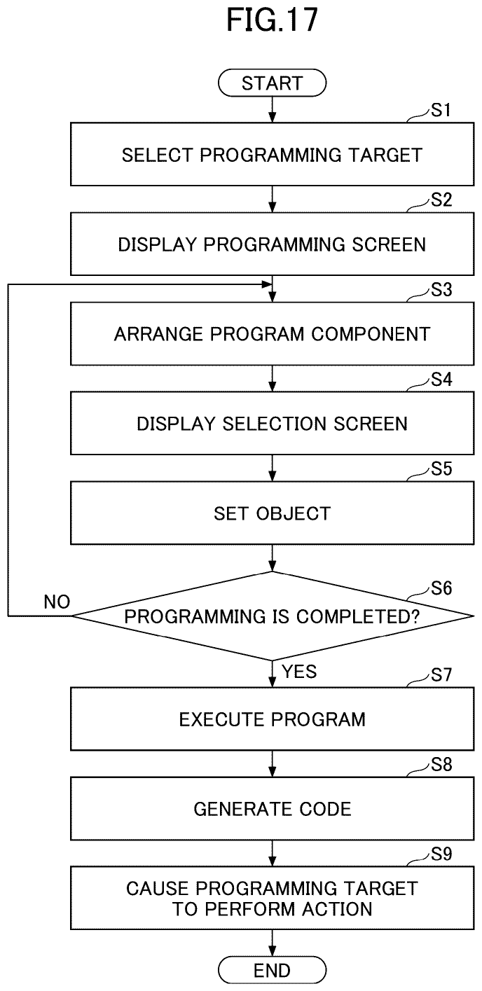

A processing procedure of an information processing method performed by the information processing device 100 according to the embodiment of the present disclosure will be described with reference to FIG. 17. FIG. 17 is a flowchart illustrating an example of the processing procedure of the information processing method.

In step S1, the operation receiving unit 101 select the controlled character to be programmed in response to the operation by the player. The operation of selecting the programming target is performed on the field screen 200. The operation receiving unit 101 sends information indicating the selected programming target to the screen display unit 102.

In step S2, the screen display unit 102 receives the information indicating the program target from the operation receiving unit 101. Next, the screen display unit 102 displays the programming screen 300 on the display device. The programming screen 300 is displayed in a state where a program for causing the controlled character 202 selected as the program target to perform the action is to be created.

In step S3, the operation receiving unit 101 receives an operation of arranging the program components. The operation of arranging the program components is performed by the player on the programming screen 300. Next, the operation receiving unit 101 sends information indicating the received operation to the programming unit 103.

The programming unit 103 arranges the program components in accordance with the content of the operation received from the operation receiving unit 101. The programming unit 103 controls the screen display unit 102 to display the arranged program components on the programming screen 300.

In step S4, the operation receiving unit 101 receives an operation of selecting a program component to be set. The operation of selecting the program component is performed by the player on the programming screen 300. The operation of selecting the program component is, for example, an operation of selecting an input field included in the arranged program component. Next, the operation receiving unit 101 sends information indicating the received operation to the object selecting unit 104.

The object selecting unit 104 controls the screen display unit 102 to display the selection screen 400 in accordance with the content of the operation received from the operation receiving unit 101. The screen display unit 102 displays the selection screen 400 on the display device.

The selection screen 400 is displayed in a state in which an object to be set in the program component selected as the setting target can be selected. Specifically, the selection screen 400 first acquires a type of the action instructed by the program component selected as the setting target, and specifies a type of an object to be a target of an action in the acquired type. Next, the selection screen 400 extracts an object that is present in the actionable range where the controlled character 202 to be programmed can act, among objects in the specified type.

Subsequently, the selection screen 400 displays a list of the extracted objects in the list area 420. Additionally, the selection screen 400 displays the position of each of the extracted objects in the map area 410. The selection screen 400 may highlight the range in which the displayed object is located. Further, the selection screen 400 displays, in the map area 410, the position of the operated character 201, the position of the controlled character 202, and the actionable range and the non-actionable range of the controlled character 202.

In step S5, the operation receiving unit 101 receives the operation of selecting the object to be set. The operation of selecting the object is performed by the player on the selection screen 400. The operation of selecting the object is, for example, an operation of selecting a desired object in the map area 410 or the list area 420 and pressing the set button 422. Next, the operation receiving unit 101 sends information indicating the received operation to the object selecting unit 104.

The object selecting unit 104 notifies the programming unit 103 of the selected object in accordance with the content of the operation received from the operation receiving unit 101. The programming unit 103 sets the notified object in the program component selected as the setting target.

In step S6, the player determines whether the programming is completed. When the programming is completed (YES), the player performs an operation of executing the program. In this case, the information processing device 100 advances the process to step S7. If the programming is not completed (NO), the player continues the operation of creating the program. For example, the player performs an operation of arranging a new program component. In this case, the information processing device 100 returns the process to step S2.

In step S7, the operation receiving unit 101 receives the operation of executing the program. The operation of executing the program is performed by the player on the programming screen 300. Next, the operation receiving unit 101 sends information indicating the received operation to the programming unit 103. The programming unit 103 sends the program created in step S3 to the code converting unit 105 in response to the operation by the player.

In step S8, the code converting unit 105 receives the program from the programming unit 103. Next, the code converting unit 105 generates the code for controlling the action of the controlled character 202, which is the programming target, based on the received program. Then, the code converting unit 105 sends the generated code to the action control unit 106.

In step S9, the action control unit 106 receives the code from the code converting unit 105. Next, the action control unit 106 controls the action of the controlled character 202 in the virtual space in accordance with the received code. Then, the action control unit 106 controls the screen display unit 102 to display the state in which the controlled character 202 is acting on the field screen 200. In the field screen 200, the controlled character 202, which is set as the programming target, performs a series of actions indicated in the program.

### Another Embodiment

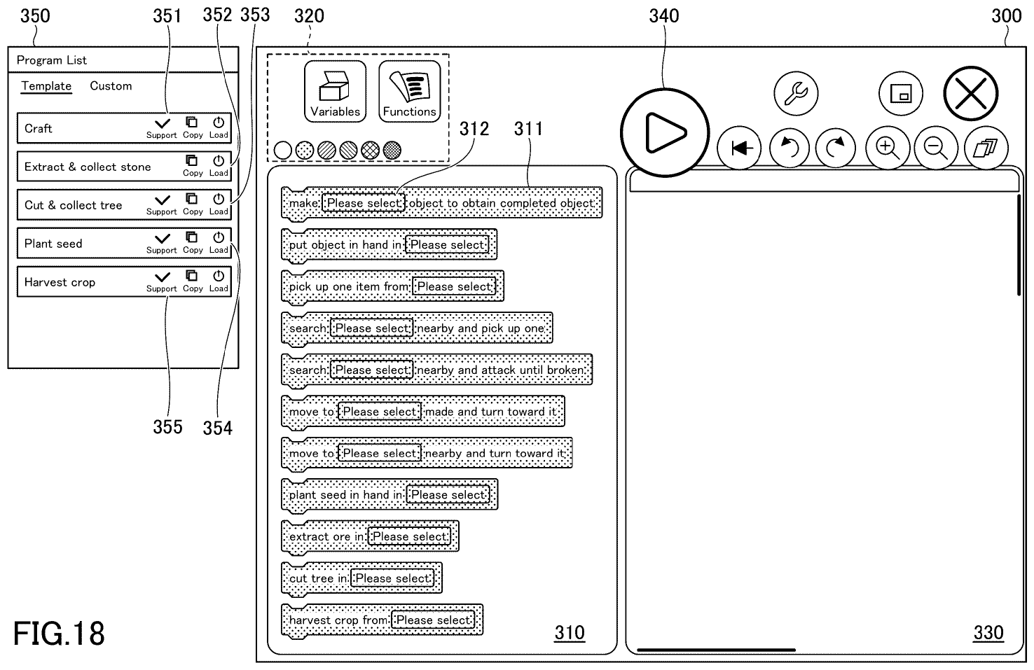

User interfaces of an information processing device according to another embodiment will be described with reference to FIG. 18 to FIG. 22. The information processing device according to another embodiment has a function of creating a program using a template created in advance.

### <Program List Screen>

FIG. 18 is a diagram illustrating an example of a program list screen according to another embodiment. As illustrated in FIG. 18, a program list screen 350 is displayed together with the programming screen 300 when the programming screen 300 is activated.

On the program list screen 350, templates 351 to 355 of the program are displayed in a selectable manner. Each of the templates 351 to 355 is a template of a program in which multiple program components are connected, and is prepared in advance, corresponding to a type of the action to be performed by the controlled character. That is, multiple types of templates are prepared corresponding to the types of actions.

The player can select, from the multiple types of templates displayed on the program list screen 350, a template corresponding to the type of the action that the player desires to cause the controlled character to perform. For example, the template 351 of “craft”, which is the action of causing the controlled character to create an item, may be prepared. When the player wants the controlled character to perform an action of creating an item, the player may select the template 351 of “craft” on the program list screen 350. In the following, the description will be continued by using, as an example, a case where the template 351 of “craft” is selected.

When a template is selected by the player on the program list screen 350, a template setting screen is activated. The activated template setting screen may be displayed in a state of being superimposed on a part or an entirety of the programming screen 300 and the program list screen 350.

### <Template Setting Screen>

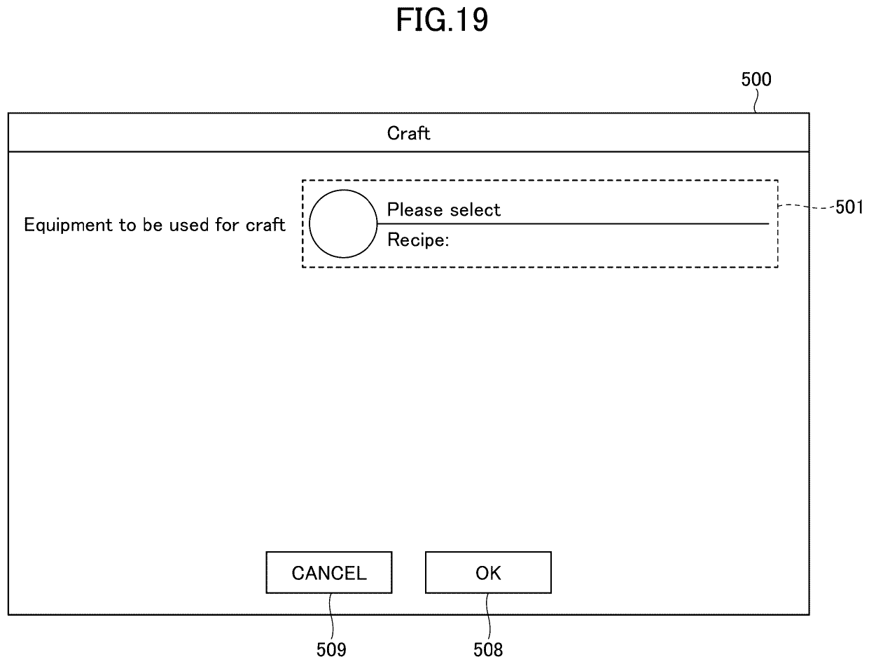

FIG. 19 is a diagram illustrating an example of the template setting screen. As illustrated in FIG. 19, a template setting screen 500 includes a setting field 501, an OK button 508, and a cancel button 509.

The template setting screen 500 is a screen for the player to set (customize) an object to be a target of an action of a type corresponding to the template selected on the program list screen 350. The template setting screen 500 associates a predetermined setting field of the template setting screen 500 with an input field of the program of the template. Specifically, the object set on the template setting screen 500 is automatically set in the input field of the program component included in the program created using the template. By using the template setting screen 500, the player can set the object in the input field without performing an operation of selecting the input field from the program (for example, an operation of clicking or tapping). Details will be described later.

The template setting screen 500 illustrated in FIG. 19, for example, allows the player to select multiple objects to be set in the program using the template in a predetermined order. For example, an initial display of the template setting screen 500 may display only the setting field 501 for the player to select a specific type of object (here, the craft, which is equipment to be used for creating an item) corresponding to the type of the action. Additionally, the template setting screen 500 may display a description (here, a text “Equipment to be used for craft”) related to an object selectable in the setting field 501 as an object set in the input field of the program of the template, in association with the setting field 501 (for example, at a position adjacent to the setting field 501). However, a display mode of the template setting screen 500 is not limited to the example illustrated in FIG. 19.

When the operation for selecting the object in the setting field 501 is performed by the player on the template setting screen 500, the selection screen 400 as illustrated in FIG. 4 is activated. Here, the operation for selecting the equipment is, for example, an operation of clicking or tapping the setting field 501 on which “Please select” is displayed.

On the selection screen 400, only objects that can be set (here, the craft, which can be used to create an item) are displayed in the map area 410 and the list area 420 in a selectable manner. The player can select the object to be set in the setting field 501 from the map area 410 or the list area 420.

The OK button 508 is a button for determining the set object. In the example illustrated in FIG. 19, because there is a setting field for which the setting is not completed, the OK button 508 is grayed out and is controlled such that the OK button 508 cannot be pressed. The cancel button 509 is a button for discarding the set object and closing the template setting screen 500.

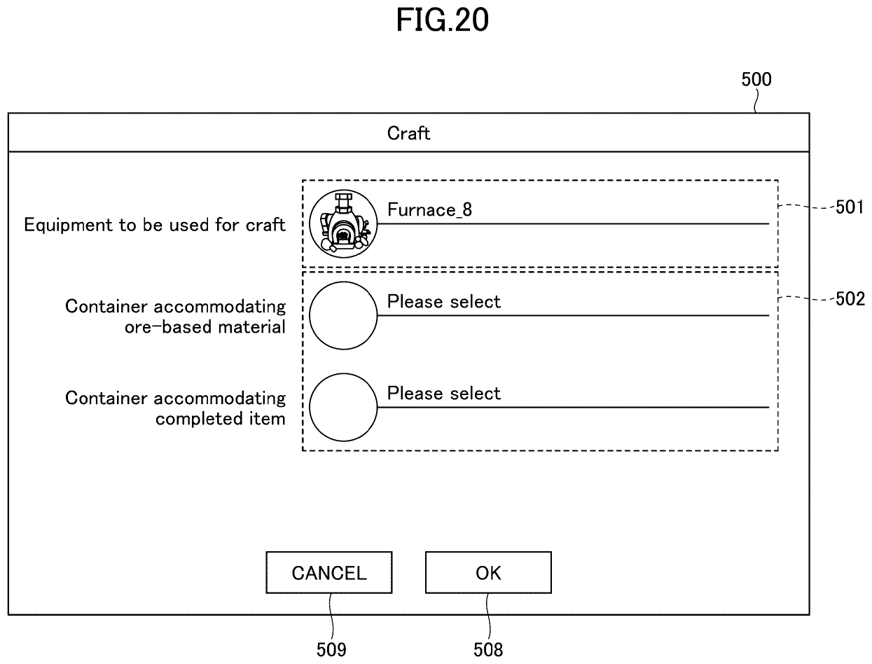

FIG. 20 is a diagram illustrating an example of the template setting screen on which the object is set. In the template setting screen 500 illustrated in FIG. 20, the object selected by the player in the selection screen 400 (here, “furnace_8”, which is the craft that is equipment used for creating an item) is set in the setting field 501.

The template setting screen 500 illustrated in FIG. 20 newly displays an additional setting field 502 when the object is set in the setting field 501, in order to allow the player to select multiple objects to be set in the template in a predetermined order. However, a display mode of the template setting screen 500 is not limited to the example illustrated in FIG. 20.

The number of the additional setting fields 502 and the type of object set in the additional setting field 502 may be determined according to any one or a combination of the type of template selected in the program list screen 350 (i.e., the type of the action to be performed by the controlled character (here, “craft”)) and the type of object set in the setting fields 501 (here, “furnace”, which is the craft).

In the template setting screen 500 illustrated in FIG. 20, the number of the additional setting fields 502 is two. A type of the object that can be set in one field of the setting fields 502 is “container” that is the inventory accommodating an “ore material”, which is an item used in “craft” using “furnace”. A type of the object that can be set in the other field of the setting fields 502 is “container” that is the inventory accommodating “completed item”, which is an item created by “craft” using “furnace”. Additionally, the template setting screen 500 may display a description (here, text “Container accommodating ore-based material” and “Container accommodating completed item”) related to the object that can be set in the setting field 502 as the object set in the input field of the program of the template, in association with the setting field 502 (for example, at a position adjacent to the setting field 502).

When the operation for selecting the object in the additional setting field 502 is performed by the player on the template setting screen 500, the selection screen 400 as illustrated in FIG. 4 is activated. Then, on the activated selection screen 400, the player can select the object to be set in the setting field 502 from the map area 410 or the list area 420.

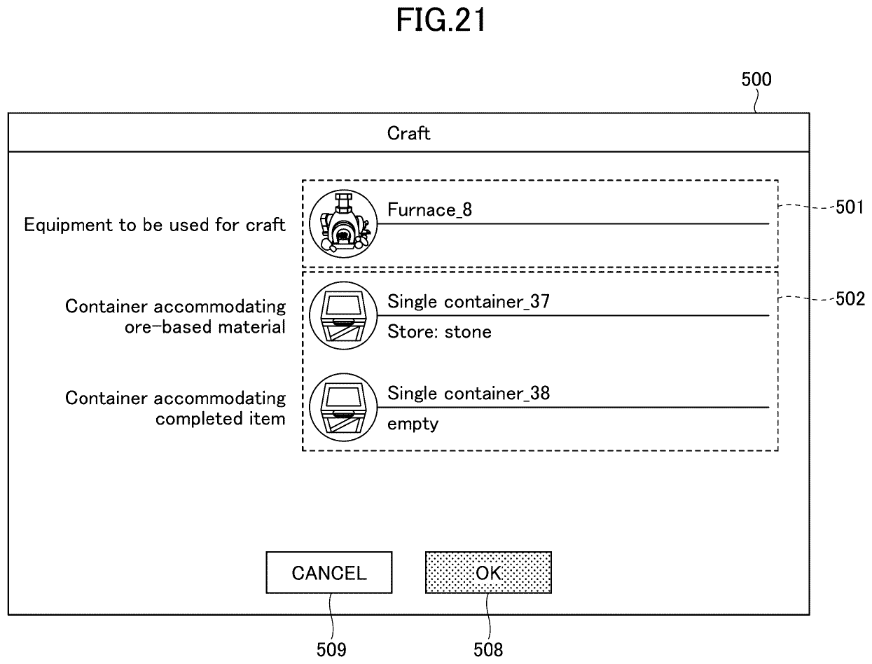

FIG. 21 is a diagram illustrating an example of the template setting screen in which the setting is completed. In the template setting screen 500 illustrated in FIG. 21, the objects selected by the player on the selection screen 400 (here, “single container 37”, which is the inventory accommodating the item used for creating the item and “single container 38”, which is the inventory accommodating the completed item created by the craft) are set in the setting fields 502. In the template setting screen 500 illustrated in FIG. 21, because the setting of the objects in all the setting fields is completed, the OK button 508 can be pressed.

When the setting of the objects in all the setting fields is completed on the template setting screen 500, an operation for setting, in the program using the template, the object set in each of the setting fields can be received. This operation is, for example, an operation of clicking or tapping the OK button 508 by the player or the like. That is, when the setting of the objects in all the setting fields is completed on the template setting screen 500, control enabling the OK button 508 to be pressed is performed.

When the player performs the operation for setting, in the program using the template, the object set in the setting field, a program in which the object set in each of the setting fields is set in the input field of the program component is created. Additionally, the created program is displayed in the arrangement area 330 of the programming screen 300.

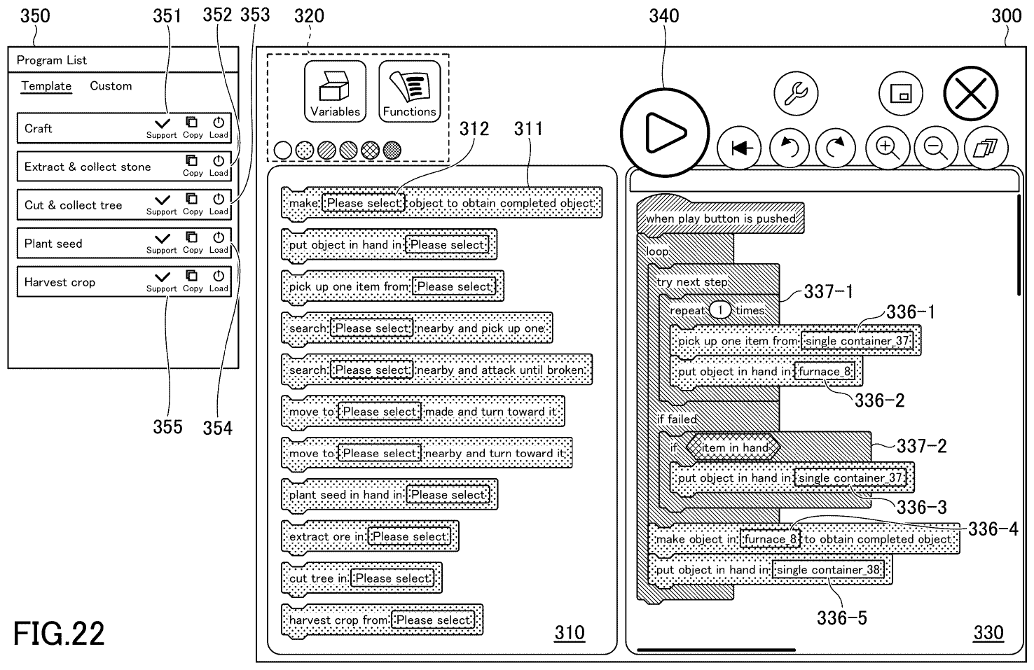

FIG. 22 is a diagram illustrating an example of the programming screen on which the program created using the template is displayed. As illustrated in FIG. 22, in the program created using the template, the object set on the template setting screen 500 is input in an input field 336 of the program component. Here, the program created using the template may include a program component that does not include the input field 336.

The program component including the input field may be displayed in a state where a default object is set in the input field, or may be displayed in a state where no object is set in the input field (for example, a state where “Please select” is displayed in the input field).

If the default object is set in the input field, the program is in a state where the program can be executed when the play button 340 is pressed. Additionally, because the input field is editable, the player can easily edit the object so as to cause the controlled character to perform a desired action.

If no object is set in the input field, the program is not executed even when the play button 340 is pressed. In this state, an unintended execution of the program can be prevented.

As described above, by preparing multiple types of program templates in accordance with the types of action that the player desires the controlled character to perform, the player can easily create a program that instructs the desired action with a small number of operations.

In another embodiment, the player is caused to select objects to be set in the program using the template in a predetermined order via the template setting screen 500 and the selection screen 400 corresponding to the type of the template selected by the player. The programming screen 300 displays a program in which the object selected via the template setting screen 500 and the selection screen 400 is automatically set.

For example, for a program using a template having multiple input fields, the player may first be caused to select objects to be set in a small number of main input fields in the type of the template via the template setting screen 500 and the selection screen 400. Then, a program in which the objects selected by the player are set in the small number of input fields and default objects are input in the other input fields may be displayed on the programming screen 300.

Here, in another embodiment, the player is caused to select the object to be set in the setting field on the template setting screen 500 via the selection screen 400 as illustrated in FIG. 4, but the object may be set without using the selection screen 400. For example, the player may be allowed to directly input the name of the object, or the player may be allowed to select the name of the selectable object from a list such as a drop-down list. That is, a user interface (for example, the template setting screen 500) that automatically sets the object selected by the player in the corresponding input field in the program using the template, without causing the player to select, from the program using the template displayed on the programming screen 300, the input field in which the object is to be set, may be provided.

In the user interface, the object selected by the player may be associated in advance with an input field, in which the object is to be set, in the program using the template. Additionally, the user interface may display information (for example, a text such as “equipment to be used for craft”, “container accommodating ore-based material”, “container accommodating completed item”, or the like) describing what the object selected by the player as the object set in the input field is.

With such a configuration, even a player who is unfamiliar with programming can easily create a program that instructs a desired operation. Additionally, the player can efficiently learn programming by referring to the program created using the template. Further, the player can create a new program by himself/herself using the program created using the template as a starting point.

### SUMMARY

As is clear from the above description, the information processing device 100 according to the embodiment of the present disclosure displays the selection screen 400 for selecting an object to be an action target of a program component indicating an action to be instructed to a character. The selection screen 400 displays the position of selectable object on a map of a space in which the character can act.

The information processing device 100 may display the selection screen 400 in response to an operation on a program component that requires setting of an object as an action target.

The selection screen 400 may display a position of an object of a type corresponding to the action instructed to the character. The selection screen 400 may display a position of the object that is present in the space in which the character can act. The selection screen 400 may display a positional relationship between the character and the object.

The selection screen 400 may display a list of selectable objects. The information processing device 100 may highlight, on the map, the position of the object selected from the list. The information processing device 100 may highlight, in the list, the position of the object selected on the map.

With this, according to the embodiment of the present disclosure, an information processing device that can easily select an object to be set in a program component can be provided.

In the related art, in order to set an object in a program component, the name of the object may be directly input, or the name of a selectable object may be selected from a list such as a drop-down list. When there are many objects of the same type, the player needs to recognize the names of the objects in advance, and often makes a mistake in selection. According to the embodiment of the present disclosure, the object can be selected by referring to a map on which selectable objects are displayed, and thus the player can easily select a desired object.

### [Hardware Configuration of Information Processing Device]

A part or all of the devices (the information processing device 100) in the above-described embodiments may be configured by hardware, or may be configured by information processing of software (a program) executed by a central processing unit (CPU), a graphics processing unit (GPU), or the like. In the case where the embodiment is configured by the information processing of software, software implementing at least a part of the functions of each device in the above-described embodiments may be stored in a non-temporary storage medium (a non-temporary computer-readable medium) such as a compact disc-read only memory (CD-ROM) or a universal serial bus (USB) memory, and may be read into a computer to perform the information processing of software. The software may be downloaded via a communication network. Further, all or a part of the processing of software may be implemented in a circuit such as an application specific integrated circuit (ASIC) or a field programmable gate array (FPGA), so that information processing by the software may be performed by hardware.

The storage medium storing the software may be a detachable storage medium such as an optical disc or a fixed medium such as a hard disk or a memory. Additionally, the storage medium may be provided inside the computer (a main storage device, an auxiliary storage device, or the like) or may be provided outside the computer.

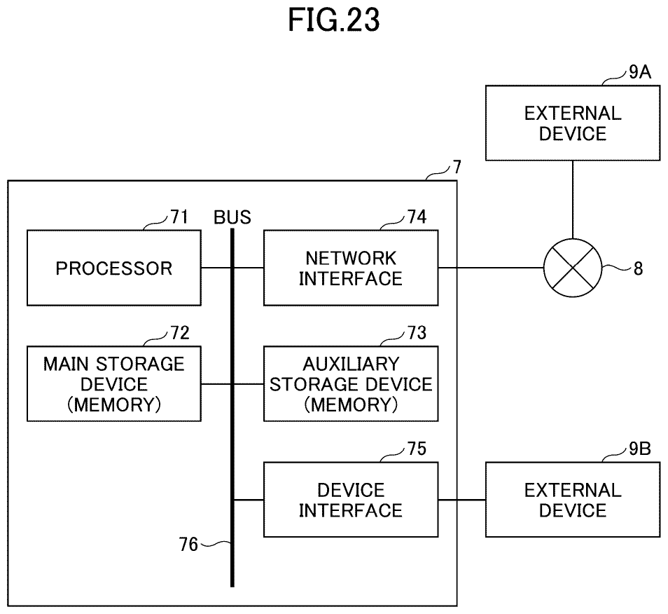

FIG. 23 is a block diagram illustrating an example of a hardware configuration of each device (the information processing device 100) according to the above-described embodiments. Each device may be implemented as a computer 7 including a processor 71, a main storage device 72 (a memory), an auxiliary storage device 73 (memory), a network interface 74, and a device interface 75, which are connected to each other via a bus 76, for example.

The computer 7 of FIG. 23 includes one of each component, but may include two or more of the same components. Additionally, although one computer 7 is illustrated in FIG. 23, software may be installed in multiple computers, and each of the multiple computers may execute the same part or different parts of the processing of the software. In this case, a form of distributed computing in which the computers communicate with each other via the network interface 74 or the like to perform the processing may be employed. That is, each device (the information processing device 100) in the above-described embodiments may be configured as a system to implement functions by one or more computers executing instructions stored in one or more storage devices. Additionally, the information transmitted from a terminal may be processed by one or more computers provided on a cloud, and the processing result may be transmitted to the terminal.

Various operations of each device (the information processing device 100) in the above-described embodiments may be executed in parallel processing using one or more processors or using multiple computers via a network. Additionally, various operations may be distributed to multiple arithmetic cores in the processor to be executed in parallel processing. Additionally, some or all of the processes, means, and the like of the present disclosure may be realized by at least one of a processor or a storage device provided on a cloud that can communicate with the computer 7 via a network. As described, each device in the above-described embodiments may be in a form of parallel computing by one or more computers.

The processor 71 may be an electronic circuit (a processing circuit, processing circuitry, a CPU, a GPU, an FPGA, an ASIC, or the like) that performs at least one of computer control or operations. Additionally, the processor 71 may be any of a general-purpose processor, a dedicated processing circuit designed to execute a specific operation, and a semiconductor device including both a general-purpose processor and a dedicated processing circuit. Additionally, the processor 71 may include an optical circuit or may include an arithmetic function based on quantum computing.

The processor 71 may perform arithmetic processing based on data or software input from each device or the like of the internal configuration of the computer 7, and may output an arithmetic result or a control signal to each device or the like. The processor 71 may control respective components constituting the computer 7 by executing an operating system (OS), an application, or the like of the computer 7.

Each device (the information processing device 100) in the above-described embodiments may be implemented by one or more processors 71. Here, the processor 71 may refer to one or more electronic circuits arranged on one chip, or may refer to one or more electronic circuits arranged on two or more chips or two or more devices. When multiple electronic circuits are used, the electronic circuits may communicate with each other by wire or wirelessly.

The main storage device 72 may store instructions executed by the processor 71, various data, and the like, and information stored in the main storage device 72 may be read by the processor 71. The auxiliary storage device 73 is a storage device other than the main storage device 72. Here, these storage devices indicate any electronic components capable of storing electronic information, and may be semiconductor memories. The semiconductor memory may be either a volatile memory or a nonvolatile memory. A storage device for storing various data and the like in each device (the information processing device 100) in the above-described embodiments may be realized by the main storage device 72 or the auxiliary storage device 73, or may be realized by a built-in memory built in the processor 71. For example, each storage unit in the above-described embodiments may be implemented by the main storage device 72 or the auxiliary storage device 73.

When each device (the information processing device 100) in the above-described embodiments includes at least one storage device (memory) and at least one processor connected (coupled) to the at least one storage device, the at least one processor may be connected to one storage device. Additionally, at least one storage device may be connected to one processor. Additionally, a configuration in which at least one processor among the multiple processors is connected to at least one storage device among the multiple storage devices may be included. Additionally, this configuration may be realized by storage devices and the processors included in multiple computers. Furthermore, a configuration in which the storage device is integrated with the processor (for example, an L1 cache or a cache memory including an L2 cache) may be included.

The network interface 74 is an interface for connecting to the communication network 8 by wire or wirelessly. As the network interface 74, an appropriate interface, such as one conforming to an existing communication standard, may be used. The network interface 74 may exchange information with an external device 9A connected via the communication network 8. Here, the communication network 8 may be any one of a wide area network (WAN), a local area network (LAN), a personal area network (PAN), and the like, or a combination thereof, as long as information is exchanged between the computer 7 and the external device 9A. Examples of the WAN include the Internet and the like, and examples of the LAN include IEEE802.11, Ethernet (registered trademark), and the like. Examples of the PAN include Bluetooth (registered trademark), Near Field Communication (NFC), and the like.

The device interface 75 is an interface, such as a USB, that is directly connected to an external device 9B.

The external device 9A is a device connected to the computer 7 via a network. The external device 9B is a device directly connected to the computer 7.

The external device 9A or the external device 9B may be, for example, an input device. The input device is, for example, a device, such as a camera, a microphone, a motion capture device, various sensors, a keyboard, a mouse, a touch panel, or the like, and gives acquired information to the computer 7. Alternatively, the device may be a device including an input unit, a memory, and a processor, such as a personal computer, a tablet terminal, or a smartphone.

Additionally, the external device 9A or the external device 9B may be, for example, an output device. The output device may be, for example, a display device, such as a liquid crystal display (LCD) or an organic electro luminescence (EL) panel, or may be a speaker that outputs sound or the like. Alternatively, the device may be a device including an output unit, a memory, and a processor, such as a personal computer, a tablet terminal, or a smartphone.

Additionally, the external device 9A or the external device 9B may be a storage device (a memory). For example, the external device 9A may be a network storage or the like, and the external device 9B may be a storage, such as an HDD.

Additionally, the external device 9A or the external device 9B may be a device having some functions of the components of each device (the information processing device 100) in the above-described embodiments. That is, the computer 7 may transmit a part or all of the processing result to the external device 9A or the external device 9B, or may receive a part or all of the processing result from the external device 9A or the external device 9B.

In the present specification (including the claims), if the expression “at least one of a, b, and c” or “at least one of a, b, or c” is used (including similar expressions), any one of a, b, c, a-b, a-c, b-c, or a-b-c is included. Multiple instances may also be included in any of the elements, such as a-a, a-b-b, and a-a-b-b-c-c. Further, the addition of another element other than the listed elements (i.e., a, b, and c), such as adding d as a-b-c-d, is included.

In the present specification (including the claims), if the expression such as “in response to data being input”, “using data”, “based on data”, “according to data”, or “in accordance with data” (including similar expressions) is used, unless otherwise noted, a case in which the data itself is used and a case in which data obtained by processing the data (e.g., data obtained by adding noise, normalized data, a feature amount extracted from the data, and intermediate representation of the data) is used are included. If it is described that any result can be obtained “in response to data being input”, “using data”, “based on data”, “according to data”, or “in accordance with data” (including similar expressions), unless otherwise noted, a case in which the result is obtained based on only the data is included, and a case in which the result is obtained affected by another data other than the data, factors, conditions, and/or states may be included. If it is described that “data is output” (including similar expressions), unless otherwise noted, a case in which the data itself is used as an output is included, and a case in which data obtained by processing the data in some way (e.g., data obtained by adding noise, normalized data, a feature amount extracted from the data, and intermediate representation of the data) is used as an output is included.

In the present specification (including the claims), if the terms “connected” and “coupled” are used, the terms are intended as non-limiting terms that include any of direct, indirect, electrically, communicatively, operatively, and physically connected/coupled. Such terms should be interpreted according to a context in which the terms are used, but a connected/coupled form that is not intentionally or naturally excluded should be interpreted as being included in the terms without being limited.

In the present specification (including the claims), if the expression “A configured to B” is used, a case in which a physical structure of the element A has a configuration that can perform the operation B, and a permanent or temporary setting/configuration of the element A is configured/set to actually perform the operation B may be included. For example, if the element A is a general purpose processor, the processor may have a hardware configuration that can perform the operation B and be configured to actually perform the operation B by setting a permanent or temporary program (i.e., an instruction). If the element A is a dedicated processor, a dedicated arithmetic circuit, or the like, a circuit structure of the processor may be implemented so as to actually perform the operation B irrespective of whether the control instruction and the data are actually attached.

In the present specification (including the claims), if a term indicating inclusion or possession (e.g., “comprising”, “including”, or “having”) is used, the term is intended as an open-ended term, including inclusion or possession of an object other than a target object indicated by the object of the term. If the object of the term indicating inclusion or possession is an expression that does not specify a quantity or that suggests a singular number (i.e., an expression using “a” or “an” as an article), the expression should be interpreted as being not limited to a specified number.

In the present specification (including the claims), even if an expression such as “one or more” or “at least one” is used in a certain description, and an expression that does not specify a quantity or that suggests a singular number (i.e., an expression using “a” or “an” as an article) is used in another description, it is not intended that the latter expression indicates “one”. Generally, an expression that does not specify a quantity or that suggests a singular number (i.e., an expression using “a” or “an” as an article) should be interpreted as being not necessarily limited to a particular number.

In the present specification, if it is described that a particular advantage/result is obtained in a particular configuration included in an embodiment, unless there is a particular reason, it should be understood that that the advantage/result may be obtained in another embodiment or other embodiments including the configuration. It should be understood, however, that the presence or absence of the advantage/result generally depends on various factors, conditions, and/or states, and that the advantage/result is not necessarily obtained by the configuration. The advantage/result is merely an advantage/result that is obtained by the configuration described in the embodiment when various factors, conditions, and/or states are satisfied, and is not necessarily obtained in the invention according to the claim that defines the configuration or a similar configuration.

In the present specification (including the claims), if multiple hardware performs predetermined processes, each of the hardware may cooperate to perform the predetermined processes, or some of the hardware may perform all of the predetermined processes. Additionally, some of the hardware may perform some of the predetermined processes while other hardware may perform the remainder of the predetermined processes. In the present specification (including the claims), if an expression such as “one or more hardware perform a first process and the one or more hardware perform a second process” is used, the hardware that performs the first process may be the same as or different from the hardware that performs the second process. That is, the hardware that performs the first process and the hardware that performs the second process may be included in the one or more hardware. The hardware may include an electronic circuit, a device including an electronic circuit, or the like.

In the present specification (including the claims), if multiple storage devices (memories) store data, each of the multiple storage devices (memories) may store only a portion of the data or may store an entirety of the data. Additionally, a configuration in which some of the multiple storage devices store data may be included.

In the present specification (including the claims), the terms “first,” “second,” and the like are used as a method of merely distinguishing between two or more elements and are not necessarily intended to impose technical significance on their objects, in a temporal manner, in a spatial manner, in order, in quantity, or the like. Therefore, for example, a reference to first and second elements does not necessarily indicate that only two elements can be employed there, that the first element must precede the second element, that the first element must be present in order for the second element to be present, or the like.

Although the embodiments of the present disclosure have been described in detail above, the present disclosure is not limited to the individual embodiments described above. Various additions, modifications, substitutions, partial deletions, and the like can be made without departing from the conceptual idea and spirit of the invention derived from the contents defined in the claims and the equivalents thereof. For example, in the embodiments described above, if numerical values or mathematical expressions are used for description, they are presented as an example and do not limit the scope of the present disclosure. Additionally, the order of respective operations in the embodiments is presented as an example and does not limit the scope of the present disclosure.

What is claimed is:

1. An information processing device comprising:
at least one memory; and
at least one processor;
wherein the at least one processor is configured to:
allow visual programming for creating a program causing a character to perform a series of actions, the program being created by combining program components; and
display a screen for selecting an object to be set in a program component indicating an action to be instructed to the character, the object being a target of the action,
wherein the screen displays a position of the object on a map of a space in which the character acts.

2. The information processing device as claimed in claim 1, wherein the at least one processor is configured to set the object selected from the map in the program component.

3. The information processing device as claimed in claim 2, wherein the at least one processor is configured to display the program component in which the object is set in a display mode indicating that the object selected from the map is set in the program component.

4. The information processing device as claimed in claim 3, wherein the display mode is configured to display a name of the object selected from the map in the program component.

5. The information processing device as claimed in claim 2, wherein the at least one processor is configured to cause the character to perform the action corresponding to the program component on the object in accordance with the program component in which the object selected from the map is set.

6. The information processing device as claimed in claim 2, wherein the at least one processor is configured to:
display the screen indicating the map corresponding to the character specified by a user; and
set the object selected from the map in the program component.

7. The information processing device as claimed in claim 1, wherein a type of the object corresponds to the action.

8. The information processing device as claimed in claim 1, wherein the map does not display a position of an object that is not the target of the action.

9. The information processing device as claimed in claim 1, wherein the screen displays a positional relationship between the character and the object.

10. The information processing device as claimed in claim 1, wherein the screen displays a list of the object with the map.

11. The information processing device as claimed in claim 10, wherein the at least one processor is configured to set, in the program component, the object selected in the list.

12. The information processing device as claimed in claim 10, wherein the at least one processor is configured to highlight the position of the object selected in the list on the map.

13. The information processing device as claimed in claim 10, wherein the at least one processor is configured to highlight, in the list, the position of the object selected on the map.

14. The information processing device as claimed in claim 10, wherein the at least one processor is configured to synchronize a selection state of the object in the map with a selection state of the object in the list.

15. The information processing device as claimed in claim 1,
wherein the at least one processor is configured to display a second screen for creating the program, the program components being arranged in the second screen and connected to make the program, and
wherein the at least one processor is configured to display the screen in response to an operation on an input field of the program component on the second screen.

16. The information processing device as claimed in claim 15, wherein the at least one processor is configured to display a third screen for setting the object in the program component included in a template of the program.

17. The information processing device as claimed in claim 16, wherein when the template includes configurable program components in which the object is configurable among the plurality of program components, the third screen displays a setting field for setting the object in one or some of the configurable program components.

18. The information processing device as claimed in claim 17, wherein the third screen displays a second setting field for setting the object in another program component when the object is set in the one or some of the configurable program components.

19. An information processing method comprising:
allowing visual programming for creating a program causing a character to perform a series of actions, the program being created by combining program components; and
displaying a screen for selecting an object to be set in a program component indicating an action to be instructed to the character, the object being a target of the action,
wherein the screen displays a position of the object on a map of a space in which the character acts.

20. A non-transitory computer-readable recording medium having stored therein a computer program for causing at least one processor to perform a process comprising:
allowing visual programming for creating a program causing a character to perform a series of actions, the program being created by combining program components; and
displaying a screen for selecting an object to be set in a program component indicating an action to be instructed to the character, the object being a target of the action,
wherein the screen displays a position of the object on a map of a space in which the character acts.
